(19) United States
(12) Patent Application Publication
(10) Pub. No.: US 2006/0141185 A1
(43) Pub. Date: Jun. 29, 2006

(54) Multi-layered sheet, container, packaged article being easy to unseal

(75) Inventor: Hiroyuki Takahashi, Sodegaura-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Idemitsu Unitech Co., LTD., Tokyo (JP)

(21) Appl. No.: 10/535,670

(22) PCT Filed: Nov. 18, 2003
(86) PCT No.: PCT/JP03/14648

§ 371 Date: Jan. 13, 2006

(30) Foreign Application Priority Data
Nov. 19, 2002 (JP) 2002-334791
Nov. 19, 2002 (JP) 2002-334792

(51) Int. Cl. B32B 27/08

(52) U.S. Cl. 428/35.7

(57) ABSTRACT

A container 3 is manufactured by thermally forming a multi-layered sheet including a first substrate layer 11, an adhesive layer 12, a gas barrier layer 13, an adhesive layer 14, a second substrate layer 15, a cohesive failure resin layer 16, and a non-cohesive failure resin layer 17 in such a manner that the non-cohesive failure resin layer 17 is positioned on an inner surface side of the container. The non-cohesive failure resin layer 17 contains a polypropylene resin having a melting point of 140° C. or higher. The thickness of the non-cohesive failure resin layer 17 is in the range of 7 to 40 μm. A circular cut portion 35 is formed on the non-cohesive failure resin layer 17.

### TECHNICAL FIELD

The present invention relates to a multi-layered sheet, a container, and a packaging article being easy to unseal.

### BACKGROUND ART

In regard to a package of foods or the like, there has been conventionally used a packaging article which includes a container manufactured by thermoforming a sheet and provided with a flange formed on a circumferential edge of a packaging object storing opening and a lid closing the opening. This packaging article is arranged in such a manner that foods or the like are inserted in the container and thereafter, the flange of the container is thermally sealed by the lid. It is preferable that such a packaging article has a high sealing performance with enhanced thermal sealing strength in preserving packaging objects. However, it is preferable that the packaging article can be easily unsealed in unsealing for use, and thus there exist needs for a packaging article having such opposite performances.

In order to meet this need, there is a method of adjusting sealing strength by resin selections in a sealing layer of the flange in the container and in a sealing layer in the lid, composition of the resins or the like. This method, however, has the problem that heat a sealing condition and an influence of attachment of the packaging object to the flange cause the sealing strength to be lowered or to be unstable.

Therefore, in order to solve this problem, there has been proposed a container where peeling strength between the innermost layer and the next layer of the container is controlled to be in the range of approximately from 5 to 15N/15 mm (prior art 1).

This container is configured by forming a circular cut portion on the innermost layer of the flange of the container and by sealing an outer circumferential side of the cut portion with the lid. In unsealing the container, a part of the innermost layer of the container sealed with the lid is peeled off together with the lid.

There has been proposed a method that the innermost layer of a multi-layered film or sheet, and a next layer (middle layer) adjacent to the innermost layer is formed with a resin layer with a cohesive failure property, where a cohesive failure strength of the next layer is lower than a cohesive failure strength of the innermost layer (see, for instance, prior art 2: Japanese Patent No. 2869136, page 1 to page 6, FIG. 4). The multi-layered film or sheet can be used as a lid, a container, and a bag. For example, in use of the multi-layered film or sheet as the lid, the innermost layer is brought in contact with the flange of the container to seal the container. And when the lid is peeled off, a part of the innermost layer and the next layer, which is thermally sealed to the flange of the container, remains on the flange, thus unsealing the container.

The method of unsealing by layer peeling in the prior art 1 as described above has the problem that peeling strength is easy to change due to variations in heat conditions or heat history in sheet forming or thermoforming of containers.

In the method of prior art 2, since the innermost layer is formed with a layer having the cohesive failure property, there is a limitation the sealing property. The resin usable in the innermost layer or the like is limited and therefore, the range of choice for the resin is narrow. As a result, it is difficult to enhance a chemical resistance, an oil resistance, or a heat resistance, for example, in accordance with an application of a packaging article.

Further, in the method of the prior art 2, the peeling is performed by edge cutting and therefore, it is required to thin the thickness of the lid or to consider a material of the lid, which results in narrowing the range of choice for the lid.

### DISCLOSURE OF THE INVENTION

An object of the present invention is to provide a packaging article being easy to unseal and a container having high sealing property and easy-unsealing property, which can achieve a performance required in accordance with an application, and a multi-layered sheet which can form the packaging article and the container. Therefore, the present invention employs the following arrangement.

A multi-layered sheet according to an aspect of the present invention includes a substrate layer, a cohesive failure resin layer formed on the substrate layer and containing a polyolefin resin and a flexible resin or an elastomer, and a non-cohesive failure resin layer formed on the cohesive failure resin layer, in which the non-cohesive failure resin layer contains a polyolefin resin with the thickness of 7 to 40 μm.

In the multi-layered sheet of the present invention, the cohesive failure resin layer is a layer, in a case where the layer is bonded strongly to another film with higher strength and a peel test is performed, which is destructed inside the layer and shows the peeling strength reduced to be 25 N/15 mm or less (JIS K 6854).

An elastic modulus of the flexible resin or the elastomer of the cohesive failure resin layer is preferably 200 MPa or less, more preferably, 150 MPa or less.

In regard to the flexible resin of the cohesive failure resin layer, for example, an ethylene-polar vinyl compound copolymer is used. For example, an ethylene-acrylic acid copolymer (EAA), an ethylene-methylacrylate copolymer (EMA), an ethylene-methacrylic acid copolymer (EMAA), an ethylene-methylmethacrylate copolymer (EMMA), an ethylene-ethylacrylate copolymer (EEA), an ethylene-ethylacrylate-maleic acid anhydride copolymer (EEA-MAH), a known ethylene-acrylic acid copolymer such as an ionomer resin, an ethylene-polyvinyl acetate copolymer, or the like can be exemplified.

In regard to the elastomer of the cohesive failure resin layer, an olefin elastomer (copolymer of amorphous ethylene and a-olefin such as propylene or butene, having a density of 900 kg/m³ or less), a styrene elastomer (a styrene-butadiene block copolymer, a styrene-butadiene random copolymer or the like), or a hydrogenated material of the above can be exemplified.

And there is no special limit in regard to a polyolefin resin of the cohesive failure resin layer, where a polypropylene resin such as homopolypropylene, random polypropylene and block polypropylene, and a polyethylene resin such as high-density polyethylene, high-pressure low-density polyethylene, or straight-chain low-density polyethylene can be exemplified. Since the cohesive failure resin layer is not a surface layer in the present invention, the heat resistance property does not have to be considered in particular, thus providing high degrees of freedom of choice.

In the multi-layered sheet of the present invention, since the thickness of non-cohesive failure resin layer is 7 μm or more, reduction of an inner pressure strength in the container can be prevented. Since the thickness of the non-cohesive failure resin layer is 40 μm or less, in a case where the container is formed with the sheet and the lid is welded thereto, an edge cutting occurs at a portion of the non-cohesive failure resin layer welded with the lid when unsealing the container. Accordingly, the welded portion and the cohesive failure resin layer with cohesive failure generated can be easily peeled off together with the lid.

Note that in a case where the thickness of the non-cohesive failure resin layer is set to be less than 7 μm, the inner pressure of the container is possibly lowered and in a case where the thickness of the non-cohesive failure resin layer is set to be more than 40 μm, an easy-unsealing property is not possibly obtained. Therefore, the thickness in the range of 7 to 40 μm is favorable.

Since the non-cohesive failure resin layer is formed on the cohesive failure resin layer, the sheet having performance in accordance with an application of the container can be provided by changing a resin used in the non-cohesive failure resin layer. For example, in the case of providing a container with a chemical resistance property, an oil resistance property, and a heat resistance property, the non-cohesive failure resin layer may be formed with a resin having the chemical resistance property, the oil resistance property, and the heat resistance property.

Further, only by optionally selecting a resin used in the non-cohesive failure resin layer, a sheet having performance in accordance with an application thereof can be produced, so that the resin used in the cohesive failure resin layer is not limited by an application of the sheet. Accordingly, the range of choice for the resin of the cohesive failure resin layer can be broadened.

Since the non-cohesive failure resin layer is formed on the cohesive failure resin layer, a smell of the flexible resin or the elastomer of the cohesive failure resin layer can be prevented.

Further, in a case where layer peeling occurs, the peeling strength easily changes due to heat history, molding such as extension, or layer thickness. Thus, it is sometimes difficult to control the peeling strength to be constant. In contrast, since the peeling is performed by producing cohesive failure in the cohesive failure resin layer in the present invention, the peeling strength becomes constant. By preventing the peeling in the boundary between the cohesive failure resin layer and the substrate layer, the peeling strength can further be stabilized.

In such arrangement, it is preferable that the substrate layer is an olefin resin, the flexible resin of the cohesive failure resin layer is an ethylene-polar vinyl compound copolymer, and the polyolefin resin of the non-cohesive failure resin layer is a polypropylene resin having a melting point of 140° C. or higher.

In a case the container is formed with the multi-layered sheet, the polypropylene resin having a melting point of 140° C. or higher is used for the non-cohesive failure resin layer which is an inner surface of the container, thereby improving heat resistance property.

Since the flexible resin of the cohesive failure resin layer contains an ethylene-polar vinyl compound copolymer, an excellent cohesive peeling property can be obtained.

It is preferable that the cohesive failure resin layer contains 50 to 95 wt % of polypropylene resin and 5 to 50 wt % of an ethylene-polar vinyl compound copolymer.

In a case where the ethylene-polar vinyl compound copolymer is less than 5 wt %, an unsealing strength becomes excessively high. On the other hand, in a case where the ethylene-polar vinyl compound copolymer is more than 50 wt %, an adhesion strength between the substrate layer and the cohesive failure resin layer is lowered and the peeling becomes unstable, so that a smooth unsealing cannot be performed. Thus, the content of the ethylene-polar vinyl compound copolymer is set to be in the range of from 5-50 wt %, thereby satisfying the easy-unsealing property and the sealing property in forming the container.

Further, it is preferable that the ethylene-polar vinyl compound copolymer of the cohesive failure resin layer is an ethylene acrylic acid copolymer or an ethylene-polyvinyl acetate copolymer.

Use of the ethylene acrylic acid copolymer or the ethylene-polyvinyl acetate copolymer as the ethylene-polar vinyl compound copolymer can produce an excellent cohesive failure property.

It is preferable that a gas barrier layer is formed on a side opposite to the cohesive failure resin layer of the substrate layer.

As the gas barrier layer, for example, a material such as polyamide, polyethylene terephthalate, ethylene-vinylalcohol copolymer, polyvinylidene chloride and the like can be used.

Formation of a gas barrier layer allows an improvement in oxidation resistance or keeping quality of a packaging object inside the packaging article when the packaging article such as a container or the like is formed with the multi-layered sheet.

A first container according to another aspect of the present invention is a container including a flange formed on a circumferential edge of an opening for storage of a package object, which is formed by thermally forming the multi-layered sheet described above, in which a non-cohesive failure resin layer of the multi-layered sheet is provided on an inner surface side of the container.

A first easily-unsealable packaging article according to still another aspect of the present invention is an easily-unsealable packaging article including the container and a lid closing an opening of the container, in which the lid is thermally sealed to the flange of the container.

It is preferable that the lid of the easily-unsealable packaging article has a gas barrier property.

A container manufactured by thermally forming the multi-layered sheet and the easily-unsealable packaging article provided with the container can achieve functions and effects similar to the multi-layered sheet. In other words, the container and the packaging article have a high-sealing property and an easy-unsealing property, so that performance in accordance with an application thereof can be achieved.

A second container according to further aspect of the present invention includes: a substrate layer; a cohesive failure resin layer formed on the substrate layer and containing a polyolefin resin and a flexible resin or an elastomer; and a non-cohesive failure resin layer formed on the cohesive failure resin layer and containing the polyolefin resin, in which the non-cohesive failure resin layer is positioned on an inner surface side of the container, and a circular cut portion is formed on the non-cohesive failure resin layer of the flange.

In the second container of the present invention, the cohesive failure resin layer, the flexible resin, the elastomer, and the polyolefin resin similar to those explained in the multi-layered sheet may be used. In the second container, however, the thickness of the non-cohesive failure resin layer on the inner surface side of the second container is not limited to 7 to 40 μm.

In the second container of the present invention, when a lid is welded to the container and a force for peeling off the lid is applied, the cohesive failure occurs in the cohesive failure resin layer. Since the cut portion is formed on the non-cohesive failure resin layer, by welding the lid to the outer circumferential side of the cut portion, a portion on the outer circumferential side of the cut portion of the non-cohesive failure resin layer and the cohesive failure resin layer where the cohesive failure has occurred can be easily peeled off together with the lid. Therefore, an easy-unsealing property can be achieved.

Since the non-cohesive failure resin layer is formed on the cohesive failure resin layer, a container having performance in accordance with an application can be provided by changing a resin used in the non-cohesive failure resin layer. For example, in a case where a container with a chemical resistance property, an oil resistance property, and a heat resistance property is required, the non-cohesive failure resin layer may be formed with a resin with the chemical resistance property, the oil resistance property, and the heat resistance property.

Further, the non-cohesive failure resin layer may be changed in accordance with an application of the container, and since the resin used in the cohesive failure resin layer is not limited to the application of the container, of the range of choice for the resin can be increased.

Since the cut portion is formed on the non-cohesive failure resin layer, the non-cohesive failure resin layer can be thickened and the resin with a high-melting point, high strength, and high rigidity can be used.

Further, in a case where the cut portion is not formed on the non-cohesive failure resin layer (first container), the peeling is required to be performed by edge cutting in a thermally sealed portion between the lid and the non-cohesive failure resin layer. In such case, it is necessary to reduce the thickness of the lid or to consider a material of the lid. In contrast, since the cut portion is formed on the non-cohesive failure resin layer in the present invention, the peeling by the edge cutting is not required to consider, so that the lid can be thickened and the lid containing an aluminum foil layer or the like can be employed. Therefore, the choice for the lid can be widened.

A second easily-unsealable packaging article according to still further aspect of the present invention includes: the second container and the lid closing an opening of the container, in which the lid is thermally sealed to the outer circumferential side of the cut portion on the flange of the container.

In the easily-unsealable packaging article of the present invention, it is preferable that the lid has a gas barrier property.

In the second easily-unsealable packaging article of the present invention, by thermally sealing the lid to the outer circumferential side of the cut portion, a portion of the flange which is thermally sealed to the lid can be easily peeled off together with the lid.

In the second easily-unsealable packaging article, it is preferable that the lid is thermally sealed to the outer circumferential side by a distance of 0.5 mm or more from the cut portion of the flange of the container.

In a case where the lid is thermally sealed to the outer circumferential side of by a distance of 0.5 mm more from the cut portion of the flange of the container, when the inner pressure in the easily-unsealable packaging article is increased, stress concentrates on a portion of the inner circumferential side of a seal portion between the lid and the flange. Since the stress is hardly applied to the cut portion, the non-cohesive failure resin layer can be prevented from peeling off from the cut portion due to the inner pressure, thereby producing the sassily-unsealable packaging article with a high pressure resistance property.

### BRIEF DESCRIPTION OF DRAWINGS

FIG. 1 is a cross section showing a multi-layered sheet according to an embodiment of the present invention;

FIG. 2 is a perspective view showing a second easily-unsealable packaging article of the embodiment;

FIG. 3 is a cross section showing the second easily-unsealable packaging article in FIG. 2;

FIG. 4 is a cross section showing a principal part of the easily-unsealable packaging article in FIG. 2;

FIG. 5 is a perspective view showing a first easily-unsealable packaging article in another embodiment of the present invention; and

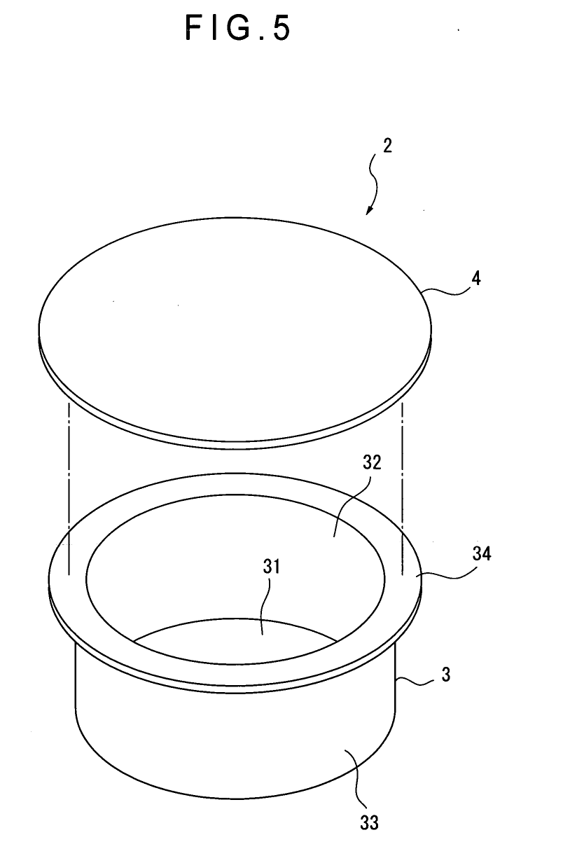

FIG. 6 is a cross section showing the easily-unsealable packaging article in FIG. 5.

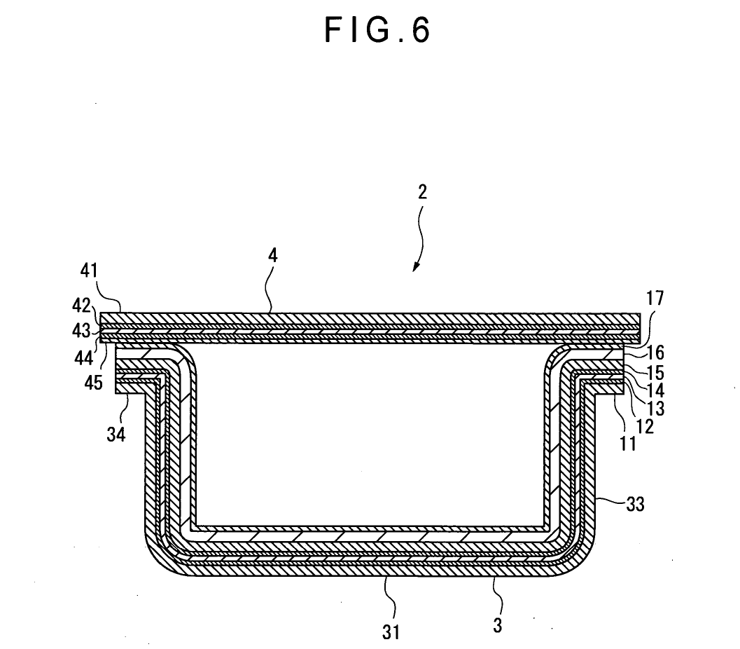

### BEST MODE FOR CARRYING OUT THE INVENTION

Embodiments of the present invention will be described with reference to the attached drawings.

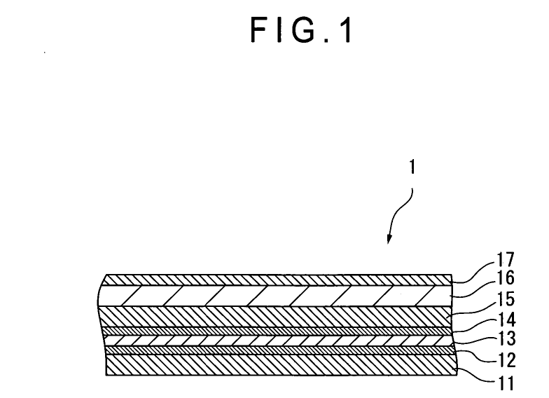

FIG. 1 shows a multi-layered sheet 1 of the present invention or a multi-layered sheet used for forming a container of the present invention. The multi-layered sheet 1 has a seven-layered structure including a first substrate layer 11, an adhesive layer 12, a gas barrier layer 13, an adhesive layer 14, a second substrate layer 15, a cohesive failure resin layer 16, and a non-cohesive failure resin layer 17.

The first substrate layer 11 and the second substrate layer 15 respectively contain a polyolefin resin, for example, a polypropylene resin as a main component. A thickness of each of the substrate layers 11 and 15 is in the range of 100 to 2000 μm, preferably from 200 to 1000 μm.

In regard to the adhesive layers 12 and 14, for example, an unsaturated carboxylic acid or a derivative modified polyolefin resin can be used.

It is preferable that a material such as polyamide, polyethylene terephthalate, ethylene-vinylalcohol copolymer, polyvinylidene chloride or the like is used as the gas barrier layer 13, and especially it is preferable that a material of the ethylene-vinylalcohol copolymer is used.

The cohesive failure resin layer 16 contains 50 to 95 wt % of the polypropylene resin and 5 to 50 wt % of the ethylene-polar vinyl compound copolymer. Especially it is preferable that the cohesive failure resin layer 16 contains the 60 to 95 wt % of polypropylene resin and 5 to 40 wt % of the ethylene-polar vinyl compound copolymer.

It is preferable that an ethylene-acrylic acid copolymer or an ethylene-polyvinyl acetate copolymer is used as the ethylene-polar vinyl compound copolymer. In regard to the ethylene-acrylic acid copolymer (Translator's comment: correctly, ethylene-polar vinyl compound copolymer), a known copolymer such as an ethylene-acrylic acid copolymer (EAA), an ethylene-methylacrylate copolymer (EMA), an ethylene-methacrylic acid copolymer (EMAA), an ethylene-methylmethacrylate copolymer (EMMA), an ethylene-ethylacrylate copolymer (EEA), an ethylene-ethylacrylate-maleic acid anhydride copolymer (EEA-MAH), and an ionomer resin can be exemplified.

As a polyethylene resin, for example, homopolypropylene, random polypropylene, block polypropylene, and the like can be exemplified.

The thickness of the cohesive failure resin layer 16 is, for example, in the range of 5 to 300 μm, preferably from 20 to 200 μm, more preferably from 10 to 200 μm, further preferably from 80 to 120 μm.

The non-cohesive failure resin layer 17 contains a polypropylene resin with a melting point of 140° C. or higher. In this case, the polypropylene resin may be, for example, a homopolypropylene or a random polypropylene. It is preferable that the thickness of the non-cohesive failure resin layer 17 is, for example, in the range of 7 to 200 μm. Specifically, when the non-cohesive failure resin layer 17 is used in a first container (without a cut portion 35 to be described later), the thickness thereof is preferably in the range from 7 to 40 μm, more preferably from 8 to 20 μm. When the non-cohesive failure resin layer 17 is used in a second container (with a cut portion 35 to be described later), the thickness thereof is preferably in the range from 40 to 200 μm, more preferably from 80 to 120 μm.

Such multi-layered sheet 1 is molded by a multi-layer extrusion method using a T die. In short, five types of extrusion machines corresponding to each of the layers 11 to 17 are used and each of the layers 11 to 17 extruded from each extrusion machine is converged and laminated by a special block right before entering into the T die.

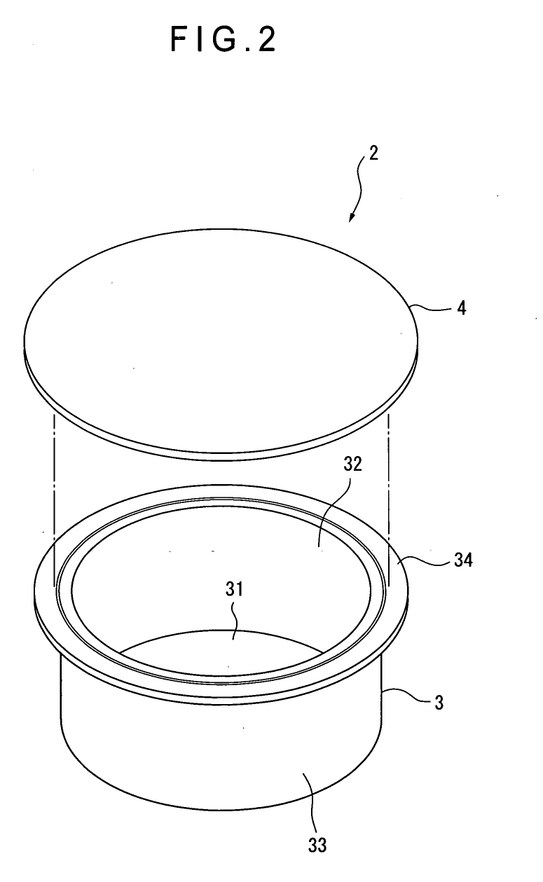

Next, a second container and a second easily-unsealable packaging article 2 according to the present invention will be explained with reference to FIG. 2. Note that the first container and the first easily-unsealable packaging article 2 of the present invention are identical to the second container and the second easily-unsealable packaging article 2 except that the first container and the first easily-unsealable packaging article 2 does not have a cut portion 35 and the thickness of the surface layer 17 (Translator's comment: correctly, non-cohesive failure resin layer 17) is defined to be from 7 to 400 μm (Translator's comment: correctly, from 7 to 40 μm).

The easily-unsealable packaging article 2 includes a container 3 and a lid 4.

The container 3 includes a circular bottom face 31 and a cylindrical side face 33 extending upright from and formed integrally with the bottom face 31 as well as having an opening 32 on the upper portion thereof, where a ringed flange 34 extending outward in a radial direction is formed integrally with an edge of the opening 32.

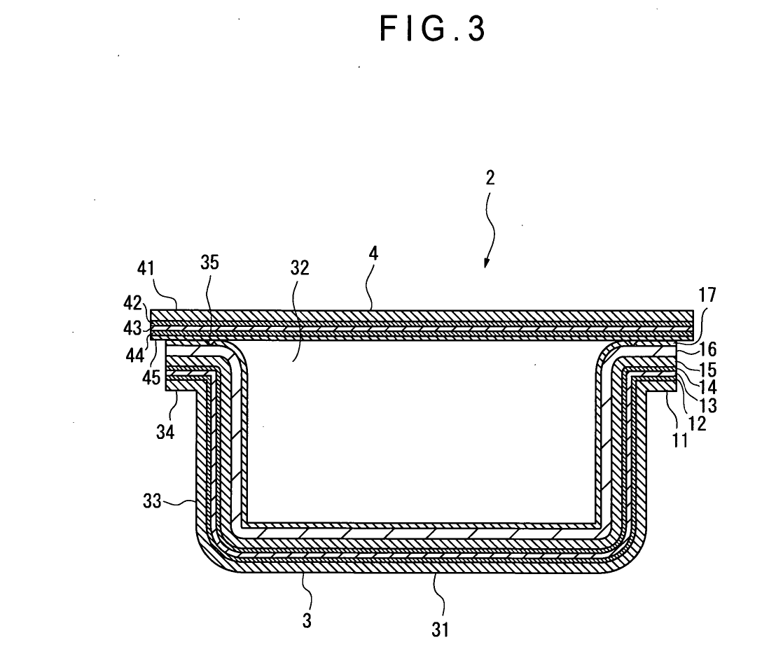

As shown in FIG. 3, the container 3 is manufactured by thermally forming the multi-layered sheet 1 in such a manner that the non-cohesive failure resin layer 17 is positioned on an inner surface side of the container 3. A method of forming the container 3 includes a method using a plug assist molding in which the multi-layered sheet 1 is pre-extended inside a cavity formed in a container contour shape by a plug, and then the container is manufactured by air-pressure forming or vacuum forming.

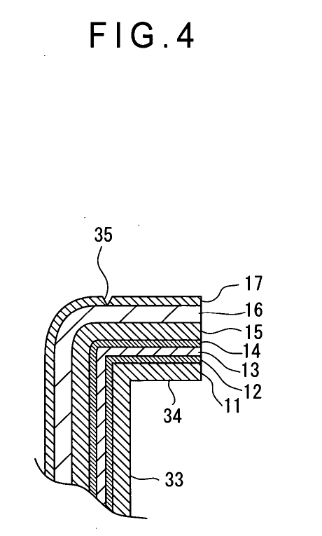

The circular cut portion 35 is formed on the non-cohesive failure resin layer 17 of the flange 34 of the container 3 so as to surround the opening 32. As shown in FIG. 4, the cut portion 35 has a V-shape cross section and the depth does not preferably reach the cohesive failure resin layer 16.

Referring back to FIG. 3, the lid 4 closes the opening 32 of the container 3 and has an outer diameter larger than an outer diameter of the flange 34 of the container 3. The lid 4 includes a first PP (polypropylene) layer 41 made of a polypropylene resin, an adhesive layer 42, a gas barrier layer 43, an adhesive layer 44, and a second PP layer 45. In the lid 4, the second PP layer 45 is a thermal seal layer, which contacts the container 3.

In regard to the gas barrier layer 43, as with the gas barrier layer 13 of the multi-layered sheet 1, a material such as polyamide, polyethylene terephthalate, ethylene-vinylalcohol copolymer, polyvinylidene chloride and the like may be used.

Materials similar to those in the adhesive layers 12 and 14 may be used also in the adhesive layer 42.

The easily-unsealable packaging article 2 is manufactured by using a circular seal ring and thermally sealing the lid 4 to the flange 34 of the container 3. The lid 4 is thermally sealed on the outer circumferential side from the cut portion 35 of the container 3 by a distance from 0.5 to 10 mm, more preferably from 1 to 5 mm.

In unsealing the easily-unsealable packaging article 2, when a force is applied in the direction for peeling off the lid 4, a cohesive failure occurs inside the cohesive failure resin layer 16. Portions of the cohesive failure resin layer 16 and the non-cohesive failure resin layer 17, which are positioned on the outer circumferential side of the cut portion 35 and are thermally sealed to the lid 4, are peeled off together with the lid 4, thereby unsealing the easily-unsealable packaging article 2.

The following advantages can be achieved according to the embodiment.

Since the cut portion 35 is formed on the non-cohesive failure resin layer 17 and the lid 4 is welded to the outer circumferential side of the cut portion 35, the portions of the cohesive failure resin layer 16 in which the cohesive failure is occurred and the non-cohesive failure resin layer 17, which is welded to the lid 4 can be peeled off together with the lid 4 when unsealing the container 3. Thus, an easy-unsealing property can be achieved.

Since the non-cohesive failure resin layer 17 is formed on the cohesive failure resin layer 16, the multi-layered sheet 1 and the container 3 having performance in accordance with the application can be provided by changing a resin used in the non-cohesive failure resin layer 17. For example, in the case of providing the container 3 with a chemical resistance property and a heat resistance property, the non-cohesive failure resin layer 17 may be formed with a resin with the chemical resistance property and the heat resistance property. In the present embodiment, the polypropylene resin having a melting point of 140° C. or higher is used for the non-cohesive failure resin layer 17, thereby producing the multi-layered sheet 1 and the container 3 with the high heat resistance property

Changing the non-cohesive failure resin layer 17 in accordance with an application of each of the multi-layered sheet 1 and the container 3 provides a desired performance, so that the resin used in the cohesive failure resin layer 16 is not limited to the application of each of the multi-layered sheet 1 and the container 3. Accordingly, the range of choice for the resin can be broadened.

Formation of the non-cohesive failure resin layer 17 on the cohesive failure resin layer 16 prevents a smell of the ethylene-acryl acid copolymer or the ethylene-polyvinyl acetate copolymer of the cohesive failure resin layer 16.

Further, in a case where layer peeling occurs, the peeling strength easily changes due to heat history, molding such as extension or the like, or layer thickness. Accordingly, it is sometimes difficult to control the peeling strength to be constant. In contrast, since in the embodiment, the peeling is performed caused by generating a cohesive failure in the cohesive failure resin layer 16, the peeling strength becomes constant. By preventing the peeling in the boundary between the cohesive failure resin layer 16 and the second substrate layer 15, the peeling strength can further be stabilized.

Since the cut portion 35 is formed on the non-cohesive failure resin layer 17, as in the embodiment, it is possible to set the thickness of the non-cohesive failure resin layer 17 to be 40 to 200 μm or to use a resin with a high-melting point, high strength, and high rigidity.

Further, in a case where the cut portion 35 is not formed on the non-cohesive failure resin layer 17, the peeling is required to be performed by edge cutting in a thermally sealed portion between the lid 4 and the non-cohesive failure resin layer 17. In this case, it is necessary to reduce the thickness of the lid 4 or to consider a material of the lid 4. In contrast, since the cut portion 35 is formed on the non-cohesive failure resin layer 17 in the embodiment, it is not required to consider the peeling by the edge cutting, thereby possibly thickening the lid 4.

Use of the ethylene-acrylic acid copolymer or the ethylene-polyvinyl acetate copolymer as the flexible resin of the cohesive failure resin layer 16 allows an excellent cohesive peeling property.

In a case where the ethylene-acrylic acid copolymer or the ethylene-polyvinyl acetate copolymer of the cohesive failure resin layer 16 is less than 5 wt %, an unsealing strength becomes excessively high. On the other hand, in a case where the ethylene-acryl acid copolymer or the ethylene-polyvinyl acetate copolymer is more than 50 wt %, an adhesion strength between the second substrate layer 15 and the cohesive failure resin layer 16 is reduced and the peeling becomes unstable, so that a smooth unsealing cannot be performed. Accordingly, by setting the content of the ethylene-acryl acid copolymer or the ethylene-polyvinyl acetate copolymer to be in the range of from 5 to 50 wt %, the easy-unsealing property and the sealing property of the container 3 can be achieved.

The container 3 includes the gas barrier layer 13, thereby improving oxidation resistance property or keeping quality of fillers in the container 3.

The lid 4 is thermally sealed to a portion on the outer circumferential side from the cut portion 35 of the flange 34 of the container 3 by a distance of 0.5 to 10 mm. As the inner pressure in the easily-unsealable packaging article 2 increases, the stress concentrates on a portion in an inner circumferential side of the seal portion between the lid 4 and the flange 34. Since the stress hardly acts on the cut portion 35, the non-cohesive failure resin layer 17 can be prevented from peeled off from the cut portion 35 due to the inner pressure, thus providing the easily-unsealable packaging article 2 with an excellent pressure resistance property.

As described above, it is explained in detail that the second container and the easily-unsealable packaging article 2 of the present invention are configured to have the circular cut portion 35 formed on the flange of the container.

The present invention is not limited to the above-described arrangement, but in a case where the thickness of the non-cohesive failure resin layer of the multi-layered sheet used in forming the container is in the range of 7 to 40 μm, the first container and the first easily-unsealable packaging article 1 are provided without formation of the circular cut portion 35 on the flange of the container.

With the arrangement, formation of the cut portion 35 is unnecessary and the easy-unsealing property requires occurrence of the edge cutting of the inner layer corresponding to the cut portion caused by the pressure in thermally sealing the lid to the flange of the container. As a result, the thickness of the innermost layer and types of the resin and the lid are limited, which requires consideration in choosing them.

In a case where the thickness of the non-cohesive failure resin layer 17 is less than 7 μm, the inner pressure strength in the container 3 tends to be lowered and when the thickness of the non-cohesive failure resin layer 17 is more than 40 μm, an easy-unsealing property is not possibly obtained. In contrast, in the present embodiment, since the thickness of the non-cohesive failure resin layer 17 is more than 7 μm, the inner pressure strength in the container 3 can be prevented from lowering. Further, since the thickness of the non-cohesive failure resin layer 17 is less than 40 μm, the edge cutting occurs in the portion of the non-cohesive failure resin layer 17 which is welded to the lid 4, when unsealing the container. Accordingly, the portion of the non-cohesive failure resin layer 17 which is welded to the lid 4 and the cohesive failure resin layer 16 in which the cohesive failure occurs can be easily peeled off together with the lid 4.

Since the portion of the non-cohesive failure resin layer 17 which is thermally sealed to the lid 4 thus produces the edge cutting and is peeled off, it is not necessary to form the cut portion on the non-cohesive failure resin layer 17, thereby saving labor in manufacturing the easily-unsealable packaging article 2.

Incidentally, the present invention is not limited to the above-described embodiment, but includes modifications and improvements within the scope of achieving the purpose of the present invention.

In the above embodiment, the ethylene-vinylalcohol copolymer as the gas barrier layer 13 is used, polyamide, polyethylene terephthalate, polyvinylidene chloride or the like may be used.

It should be noted by forming the gas barrier layer 13 with the ethylene-vinylalcohol copolymer, a good formation property and a high sealing property can be obtained.

Further, the multi-layered sheet 1 and the container 3 includes the gas barrier layer 13, but the gas barrier layer 13 may not be provided when the packaging object has an oxidation resistance property. With the arrangement, it is possible to provide the multi-layered sheet 1 and the container 3 at a low price.

Further, the ethylene-polar vinyl compound copolymer of the cohesive failure resin layer 16 is the ethylene-acrylic acid copolymer or the ethylene-polyvinyl acetate copolymer, but a different ethylene-polar vinyl compound copolymer or a different flexible resin may be used.

Instead of using the flexible resin of the ethylene-polar vinyl compound copolymer or the like, an elastomer such as an olefin elastomer (copolymer of amorphous ethylene and a-olefin such as propylene or butene, having a density of 900 kg/m³ or less), a styrene elastomer (a styrene-butadiene block copolymer, a styrene-butadiene random copolymer or the like), or a hydrogenated material of them may be used.

The cohesive failure resin layer 16 contains 50 to 95 wt % of the polypropylene resin and 5 to 50 wt % of the ethylene-polar vinyl compound copolymer, but the mixing ratio is not limited thereto.

Although the polypropylene resin is contained in the cohesive failure resin layer 16, a different polyolefin resin may be contained therein. Since the non-cohesive failure resin layer is formed on the cohesive failure resin layer and the cohesive failure resin layer is not a surface layer, it is not necessary to consider especially a heat resistance property or the like, so that a polyolefin resin to be used can be freely chosen. For example, the cohesive failure resin layer 16 may contain a polyethylene resin instead of the polypropylene resin.

The polyolefin resin of the non-cohesive failure resin layer 17 includes a polypropylene resin having a melting point of 140° C. or higher, but when the heat resistance property is not required, for example, a polyethylene or the like may be used.

In the above embodiment, the lid 4 made of resin is used, but a lid having a metal foil, a metal evaporation film, or an inorganic evaporation film of aluminum or the like may be used instead. The second container 3 of the present invention has the cut portion 35 formed on the non-cohesive failure resin layer 17 and therefore, which does not require peeling by edge cutting. Accordingly, the lid as described above can be used.

The lid 4 is thermally sealed on the outer circumferential side from the cut portion 35 on the flange 34 of the container 3 by a distance in the range of 0.5 to 10 mm, but the lid 4 may be thermally sealed on the outer circumferential side by a distance more than 10 mm and may be thermally sealed on the outer circumferential by a distance less than 0.5 mm.

In the above embodiment, the thickness of the non-cohesive failure resin layer 17 is in the range of 40 to 200 μm, but the thickness is not limited thereto.

Further, in the embodiment, the flange 34 of the container 3 is a flat flange extending outward in parallel to a plane of the opening 32, but the flange 34 may be a skirt flange having an angular C-shape cross section and extending outward in parallel to the plane of the opening 32 and hanging down at the outermost edge or a curl flange. In this case, a cut portion may be formed in a hanged portion of the flange.

In the above embodiment, the container 3 is formed using the multi-layered sheet 1, but a lid or a bag may be formed using the multi-layered sheet 1.

Further, the multi-layered sheet 1 is molded by a multi-layer extrusion method using a T die, but may be molded by a different molding method. For example, the multi-layered sheet 1 may be molded by a dry laminate or an extrusion laminate.

In the above embodiment, the width of the thermal sealing is 5 mm and the temperature of the thermal sealing is from 170 to 230° C., but the conditions are not limited to thereto as long as the non-cohesive failure resin layer 17 and the cohesive failure resin layer 16 of the container 3 are peeled off together with the lid 4 when unsealing.

The present invention will be explained in more detail with reference to examples and comparative examples.

### EXAMPLE 1

(1) Multi-Layered Sheet 1

The multi-layered sheet 1 shown in the above embodiment is molded by a co-extrusion molding.

(1-1) First Substrate Layer 11

Raw resin: polypropylene (E-203GK manufactured by Idemitsu Petrochemical Co., Ltd.)

Layer thickness: 200 μm

(1-2) Adhesive Layer 12

Raw resin: adhesive resin (ADMER QF-500 manufactured by Mitsui Chemicals, Inc.)

Layer thickness: 20 μm

(1-3) Gas Barrier Layer 13

Raw resin: ethylene-vinylalcohol copolymer (EVAL J-102 B manufactured by KURARAY CO., LTD.)

Layer thickness: 50 μm

(1-4) Adhesive Layer 14

Raw resin: adhesive resin (ADMER QF-500 manufactured Mitsui Chemicals, Inc.)

Layer thickness: 20 μm

(1-5) Second Substrate Layer 15

Raw resin: polypropylene (E-203GK manufactured by Idemitsu Petrochemical Co., Ltd.)

Layer thickness: 350 μm

(1-6) Cohesive Failure Resin Layer 16

Raw resin: mixture of 70 wt % of polypropylene (E-105 GM manufactured by Idemitsu Petrochemical Co., Ltd.) and 30 wt % of ethylene-acrylic acid estermaleic anhydride copolymer resin (manufactured by Japan Polyolefin Co., Ltd, flexural modulus: 80 MPa)

Melting point (measured by DSC method): 99° C.

MFR (measured in accordance with JIS K6760): 8 g/10 minutes

Layer thickness: 200 μm

(1-7) Non-Cohesive Failure Resin Layer 17

Raw resin: random polypropylene

Melting point: 145° C.

Layer thickness: 40 μm

(2) Container 3

The multi-layered sheet 1 was molded into the container 3 having the opening 32 of 64 mm in diameter, the bottom face 31 of 50 mm in diameter, and the flange 34 of 8 mm in width by a plug-assist air pressure thermoforming. The circular cut portion 35 was formed on the flange 34 of the container 3.

(3) Lid 4

The lid 4 was molded by co-extrusion molding.

(3-1) PP layer 41

Raw resin: random polypropylene

Layer thickness: 200 μm

(3-2) Adhesive Layer 42

Raw resin: adhesive resin (ADMER QF-500 manufactured by Mitsui Chemicals, Inc.)

Layer thickness: 30 82 m

(3-3) Gas Barrier Layer 43

Raw resin: ethylene-vinylalcohol copolymer (EVAL J-102 B manufactured by KURARAY CO., LTD.)

Layer thickness: 40 μm

(3-4) Adhesive layer 44

Raw resin: adhesive resin (ADMER, Mitsui Chemicals, Inc.)

Layer thickness: 30 μm

(3-5) PP layer 45

Raw resin: random polypropylene

Layer thickness: 40 μm

(4) Easily-Unsealable Packaging Article 2

After filling the container 3 with a jelly, the lid 4 was welded. Specifically, a first seal portion was formed on the outer peripheral side at a position 2 mm away from the cut portion 35 of the flange 34 using the circular seal ring having a width of 5 mm under the condition of 190° C., 15 MPa, and 1.5 seconds. Further, the second seal portion was formed along a central portion in the width direction of the first seal portion, using the ring seal having a width of 2 mm. The second seal portion has an extending seal portion projecting outward at a position corresponding to a back side of an unsealing tab of the lid 4.

Further, the retorting was carried out for the easily-unsealable packaging article 2 at 120° C. for 30 minutes.

(Evaluation Method and Result)

The peeling strength and the inner pressure strength of the easily-unsealable packaging article 2 were measured.

The peeling strength was measured by performing the peel test at 180° C. (JIS K 6854) using a test piece cut out in a width of 15 mm.

And the inner pressure strength was measured by a method which was performed by injecting the air into the easily-unsealable packaging article 2.

The peeling strength was 15 N/15 mm and the inner pressure strength was 0.05 MPa before retorting the easily-unsealable packaging article 2. The peeling strength was 14 N/15 mm and the inner pressure strength was 0.05 MPa after retorting the easily-unsealable packaging article 2.

As described above, it was confirmed that the idealistic easily-unsealable packaging article 2 with a low unsealing strength while keeping sufficient inner pressure strength obtained.

Next, the following comparative experiment was performed to confirm the effects of the present invention.

### COMPARATIVE EXAMPLE 1

The comparative example 1 is to the same as the example 1 except that the non-cohesive failure resin layer 17 of the container was not formed.

(Evaluation Method and Result)

The inner pressure strength and the peeling strength were measured by a measurement method similar to the example 1.

In the comparative example, the peeling strength was 14 N/15 mm and the inner pressure strength was 0.03 MPa before retorting, and the peeling strength was 13 N/15 mm and the inner pressure strength was 0.03 MPa after retorting.

In the comparative example, it became thus clear that the pressure resistance strength was low and a sufficient sealing property was not obtained.

### EXAMPLE 2

The example 2 of the present invention will be explained. The example 2 is basically similar to the example 1 and partially differs in settings. Therefore, in the following explanation, portions identical to those in the example 1 are omitted and the differences are mainly explained

(1) Multi-Layered Sheet 1

The following conditions differ in regard to the multi-layered sheet 1.

(1-7) Non-Cohesive Failure Resin Layer 17

Raw resin: random polypropylene

Melting point: 145° C.

Layer thickness: 10 μm

(2) Container 3

The circular cut portion 35 was not formed on the flange 34 of the container 3. The other conditions were the same.

(3) Lid 4

The following conditions differ in regard to the lid 4.

(3-1) PP Layer 41

Raw resin: random polypropylene

Layer thickness: 240 μm

(3-5) PP Layer 45

Raw resin: random polypropylene

Layer thickness: 10 μm

(4) Easily-Unsealable Packaging Article 2

After filling the container 3 with the jelly, the easily-unsealable packaging article 2 was manufactured by thermally sealing the lid 4 using the circular seal ring having a width of 5 mm under the condition of 190° C., 15 MPa, and 1.5 seconds. Further, the retorting was carried out to the easily-unsealable packaging article 2 at 120° C. for 30 minutes.

(Evaluation Method and Result)

The test method was the same as in the example 1.

The test results were as follows.

The peeling strength was 17 N/15 mm and the inner pressure strength was 0.06 MPa before retorting, and the peeling strength was 15 N/15 mm and the inner pressure strength was 0.06 MPa after retorting.

As described above, it was confirmed that the idealistic easily-unsealable packaging article 2 with a low unsealing strength while keeping sufficient inner pressure strength was manufactured.

Next, the following comparative experiment was performed to confirm the effects of the present invention.

### COMPARATIVE EXAMPLE 2-1

The comparative example 2-1 is identical to the example 2 except that the non-cohesive failure resin layer 17 of the container was set to 2 μm thick.

### COMPARATIVE EXAMPLE 2-2

The comparative example 2-2 is identical to the example 2 except that the non-cohesive failure resin layer 17 of the container was set to 50 μm thick.

(Evaluation Method and Result)

The inner pressure strength and the peeling strength were measured by a measurement method similar to the example 1.

In the comparative example 2-1, the peeling strength was 7 N/15 mm and the inner pressure strength was 0.02 MPa before retorting, and the peeling strength was 6 N/15 mm and the inner pressure strength was 0.02 MPa after retorting.

In the comparative example 2-2, the peeling strength was 51 N/15 mm and the inner pressure strength was 0.12 MPa before retorting, and the peeling strength was 48 N/15 mm and the inner pressure strength was 0.11 MPa after retorting.

In the comparative example 2-1, thus the inner pressure strength was low and in the comparative example 2-2, the sufficient unsealing property was not obtained.

### INDUSTRIAL APPLICABILITY

The present invention can be used as a container or an easily-unsealable packaging article for packaging foods or the like and further, as a multi-layered sheet suitable for the container or the like.

1. A multi-layered sheet comprising:
a substrate layer;
a cohesive failure resin layer formed on the substrate layer and containing a polyolefin resin and a flexible resin or an elastomer; and
a non-cohesive failure resin layer formed on the cohesive failure resin layer, wherein:
the non-cohesive failure resin layer contains a polyolefin resin and has a thickness in the range of 7 to 40 μm.

2. The multi-layered sheet according to claim 1, wherein:
the substrate layer is a polyolefin resin;
the cohesive failure resin layer is an ethylene-polar vinyl compound copolymer as the flexible resin; and
the polyolefin resin of the non-cohesive failure resin layer is a polypropylene resin having a melting point of 140° C. or higher.

3. The multi-layered sheet according to claim 2, wherein:
the cohesive failure resin layer contains a polypropylene resin in the range of 50 to 95 wt % and an ethylene-polar vinyl compound copolymer in the range of 5 to 50 wt %.

4. The multi-layered sheet according to claim 2, wherein:
the ethylene-polar vinyl compound copolymer of the cohesive failure resin layer is an ethylene acrylic acid copolymer or an ethylene-polyvinyl acetate copolymer.

5. The multi-layered sheet according to claim 1, further comprising:
a gas barrier layer formed on a side opposite to the cohesive failure resin layer of the substrate layer.

6. A container comprising:
a flange formed on a peripheral edge of an opening for storage of a packaging object, wherein:
the container is formed by thermally forming the multi-layered sheet according to claim 1; and
a non-cohesive failure resin layer of the multi-layered sheet is positioned on an inner surface side of the container.

7. An easily-unsealable packaging article comprising:
the container according to claim 6; and
a lid for closing an opening of the container, wherein:
the lid is thermally sealed to a flange of the container.

8. A container comprising:
a substrate layer;
a cohesive failure resin layer formed on the substrate layer and containing a polyolefin resin and a flexible resin or an elastomer; and
a non-cohesive failure resin layer formed on the cohesive failure resin layer and containing a polyolefin resin, wherein:
the non-cohesive failure resin layer is positioned on an inner surface side of the container; and
a circular cut portion is formed on the non-cohesive failure resin layer of the flange.

9. The container according to claim 8, wherein:
the substrate layer is a polyolefin resin;
the cohesive failure resin layer is an ethylene-polar vinyl compound copolymer as the flexible resin; and
the polyolefin resin of the non-cohesive failure resin layer is a polypropylene resin having a melting point of 140° C. or higher.

10. The container according to claim 9, wherein:
the cohesive failure resin layer contains a polypropylene resin in the range of 50 to 95 wt %; and the ethylene-polar vinyl compound copolymer in the range of 5 to 50 wt %.

11. The container according to claim 9, wherein:
the ethylene-polar vinyl compound copolymer of the cohesive failure resin layer is an ethylene-acrylic acid copolymer or an ethylene-polyvinyl acetate copolymer.

12. The container according to claim 8, further comprising:
a gas barrier layer formed on a side opposite to the cohesive failure resin layer of the substrate layer.

13. An easily-unsealable packaging article comprising:
the container according to claim 8; and
a lid closing an opening of the container, wherein:
the lid is thermally sealed on an outer peripheral side of the cut portion on a flange of the container.

14. The easily-unsealable packaging article according to claim 13, wherein:
the lid is thermally sealed on the outer peripheral side away from the cut portion on the flange of the container by a distance of 0.5 mm or more.
